(19) United States
(12) Patent Application Publication
(10) Pub. No.: US 2004/0251237 A1
(43) Pub. Date: Dec. 16, 2004

(54) Circuit breaker with bonded bushing insulators

(76) Inventors: Jeffry R. Meyer, Greensburg, PA (US); Willie B. Freeman, Irwin, PA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/461,063

(22) Filed: Jun. 13, 2003

(51) Int. Cl. H01H 33/18

(52) U.S. Cl. 218/43

(57) ABSTRACT

A preferred embodiment of a circuit breaker includes a tank having a main portion for housing an interrupter assembly, a bushing insulator adhesively bonded to the tank, and an electrical conductor extending through the bushing insulator and electrically coupled to the interrupter assembly.

### FIELD OF THE INVENTION

The present invention relates to circuit breakers of the type comprising an interrupter, a tank for housing the interrupter, and bushing insulator secured to the tank.

### BACKGROUND OF THE INVENTION

FIG. 9 depicts a conventional circuit breaker 100 comprising a puffer interrupter assembly 101, and a tank 102. The tank 102 includes a substantially cylindrical main portion 103 for housing the puffer interrupter assembly 101. The tank 102 also includes an entrance bushing nozzle 104, and a substantially identical exit bushing nozzle 106. The entrance and exit bushing nozzles 104, 106 each adjoin the main portion 103.

The circuit breaker 100 also comprises an entrance bushing insulator 108 and an exit bushing insulator 109. The entrance bushing insulator 108 and the exit bushing insulator 109 are mounted on the respective entrance bushing nozzle 104 and exit bushing nozzle 106. More particularly, the entrance and exit bushing insulators 108, 109 each have a flange 110 formed on lower portion thereof (from the perspective of FIG. 9). The entrance and exit bushing nozzles 104, 106 each have a flange 111 formed on an upper portion thereof.

The flange 111 on the entrance bushing nozzle 104 is mated with the flange 110 on the entrance bushing insulator 108 using conventional fasteners, thereby securing the entrance bushing insulator 108 to the entrance bushing nozzle 104. The flange 111 on the exit bushing nozzle 106 is likewise mated with the flange 111 on the exit bushing insulator 109 using conventional fasteners, thereby securing the exit bushing insulator 109 to the exit bushing nozzle 106.

The circuit breaker 100 further comprises an entrance conductor 112 and a substantially identical exit conductor 114. The entrance conductor 112 is fixedly coupled to an end cap 116 of the entrance bushing insulator 108, and extends through the entrance bushing insulator 108. The exit conductor 114 is fixedly coupled to an end cap 116 of the exit bushing insulator 109, and extends through the exit bushing insulator 109.

Electrical current can flow into the circuit breaker 100 by way of the entrance conductor 112. The puffer interrupter assembly 101 forms an electrical path between the entrance conductor 112 and the exit conductor 114. The puffer interrupter assembly 101 can interrupt the flow of electrical current between the entrance and exit conductors 112, 114 on a selective basis.

The circuit breaker 100 also includes a first current transformer 116 and a substantially identical second current transformer 118. The first current transformer 116 is positioned around the entrance bushing nozzle 104, and around a lower portion of the entrance bushing insulator 108. The first transformer 116 is thus positioned around the flanges 110, 111 of the respective entrance bushing insulator 108 and entrance bushing nozzle 104.

The second current transformer 118 is positioned the exit bushing nozzle 106, and around a lower portion of the exit bushing insulator 109. The second current transformer 118 is thus positioned around the flanges 110, 111 of the respective exit bushing insulator 109 and exit bushing nozzle 104.

The first current transformer 116 is electrically coupled to the entrance conductor 112, and to an ammeter (not shown) that provides an indication of the current passing through the entrance conductor 112. The second current transformer 118 is electrically coupled to the exit conductor 114, and to an ammeter (not shown) that provides an indication of the current passing through the exit conductor 114.

The first current transformer 116 is enclosed by a metallic cover 120, and the second current transformer 118 is enclosed by a second of the covers 120.

The circuit breaker 100 also comprises two voltage shields 122. The voltage shields 122 can help to shape the voltage fields around the entrance conductor 112 and the exit conductor 114, and can help to prevent electrical failure of the circuit breaker 8.

A first of the voltage shields 122 is positioned within a lower portion of the entrance bushing insulator 108, as shown in FIG. 9. The voltage shield 122 is secured to the flange 111 of the entrance bushing nozzle 104 using conventional fasteners. The second of the voltage shields 122 is positioned within a lower portion of the exit bushing insulator 108, and is secured to the flange 111 of the exit bushing nozzle 106 using conventional fasteners.

The free volume within the puffer interrupter assembly 101 and the entrance and exit bushing insulators 108, 109 is filled with a dielectric gas such as sulfur hexafluoride (SF₆). The SF₆ gas can be pressurized to, for example, approximately four to seven atmospheres. The pressurized SF₆ is used to cool and quench the arcs that form within the puffer interrupter assembly 101 as the puffer interrupter assembly 101 interrupts the flow of electrical current between the entrance and exit conductors 112, 114. The SF₆ gas can also act as an electrical insulator between the walls of the tank 102 and the various components housed therein.

The flange 111 on the entrance bushing nozzle 104 is mated with the flange 110 on the entrance bushing insulator 108 using conventional fasteners, and the flange 111 on the exit bushing nozzle 106 is likewise mated with the flange 110 on the exit bushing insulator 109 using conventional fasteners, as discussed above. The resulting joints between the flanges 110, 111 are potential sources of leakage for the pressurized SF₆ gas. Such leakage can result, for example, from stretching or loosening of the fasteners over time, or from uneven mating pressure around the circumference of each joint due to the spacing of the fasteners. Moreover, the need to cast the flanges 111 into the tank 102 can increase the time and expense associated with manufacturing the tank 102.

The first and second current transformers 116, 18 are each positioned around the flanges 111 of the respective entrance and exit bushing nozzles 104, 106, and around the flanges 110 of the respective entrance and exit bushing insulators 108, 109, as noted above. The need to accommodate the flanges 110, 111 within the first and second current transformers 116, 118 can require that the first and second current transformers 116, 118 each have a larger overall diameter and weight than would otherwise be required. In addition, the need to secure the voltage shields 122 to the flanges 111 as shown in FIG. 9 can also necessitate a larger overall diameter and weight for the first and second current transformers 116, 118 than would otherwise be required.

### SUMMARY OF THE INVENTION

A preferred embodiment of a circuit breaker comprises a first and a second bushing insulator, and a first and a second electrical conductor extending through the respective first and second bushing insulators. The preferred embodiment also comprises a tank having a main portion for housing a puffer interrupter assembly, and a first and a second bushing nozzle adjoining the main portion. The first bushing insulator and the second bushing insulator are fixedly coupled to the respective first and second bushing nozzles by an adhesive material.

Another preferred embodiment of a circuit breaker comprises an electrical conductor, and a bushing insulator comprising a jacket for insulating the electrical conductor. The preferred embodiment also comprises a tank having a main portion for housing an interrupter assembly electrically coupled to the electrical conductor, and a bushing nozzle adjoining the main portion. The preferred embodiment further comprises an adhesive joint formed between the bushing insulator and the bushing nozzle for securing the bushing insulator to the tank and sealing an interface between the bushing insulator and the tank.

Another preferred embodiment of a circuit breaker comprises a tank having a main portion for housing an interrupter assembly, a bushing insulator adhesively bonded to the tank, and an electrical conductor extending through the bushing insulator and electrically coupled to the interrupter assembly.

Another preferred embodiment of a circuit breaker comprises a bushing insulator comprising an outer jacket and a substantially cylindrical inner sleeve concentrically disposed within the outer jacket so that a portion of the inner sleeve projects from the outer jacket. The preferred embodiment also comprises an electrical conductor extending through the bushing insulator, a tank having a main portion for housing an interrupter assembly, and a bushing nozzle having a lower portion adjoining the main portion of the tank and an upper portion for receiving the portion of the inner sleeve.

A preferred method for assembling a circuit breaker comprises providing a tank for housing an interrupter assembly, providing a bushing insulator for insulating an electrical conductor, and bonding the bushing insulator to the tank using an adhesive material.

### BRIEF DESCRIPTION OF THE DRAWINGS

The foregoing summary, as well as the following detailed description of a preferred embodiment, is better understood when read in conjunction with the appended drawings. For the purpose of illustrating the invention, the drawings show an embodiment that is presently preferred. The invention is not limited, however, to the specific instrumentalities disclosed in the drawings. In the drawings:

FIG. 1 is a cross-sectional side view of a preferred embodiment of a circuit breaker;

FIG. 2 is a side view of a tank of the circuit breaker shown in FIG. 1;

FIG. 3 is a cross-sectional side view of an entrance bushing insulator, an entrance bushing nozzle, an entrance conductor, a voltage shield, and a current transformer of the circuit breaker shown in FIG. 1, in an assembled state;

FIG. 4 is a cross-sectional, exploded side view of the entrance bushing insulator and the entrance bushing nozzle shown in FIG. 3, in an unassembled state;

FIG. 5 is a top view of the entrance bushing nozzle shown in FIGS. 3 and 4;

FIG. 6 is a side view of the voltage shield of the circuit breaker shown in FIG. 3;

FIG. 7A is a cross-sectional side view of the entrance bushing insulator, entrance bushing nozzle, entrance conductor, and current transformer shown in FIG. 3, and an alternative embodiment of the voltage shield shown in FIGS. 3 and 6;

FIG. 7B is a magnified view of the area of the voltage shield designated “A” in FIG. 7A, before the voltage shield is installed on the entrance busing nozzle;

FIG. 7C is a magnified view of the area of the voltage shield designated “A” in FIG. 7A, after the voltage shield is installed on the entrance busing nozzle;

FIG. 8 is a cross-sectional side view of the entrance bushing insulator, entrance conductor, and current transformer shown in FIG. 3, an alternative embodiment of the entrance bushing nozzle shown in FIG. 3, and another alternative embodiment of the voltage shield shown in FIGS. 3 and 6; and

FIG. 9 is a cross-sectional side view of a conventional circuit breaker.

### DESCRIPTION OF PREFERRED EMBODIMENTS

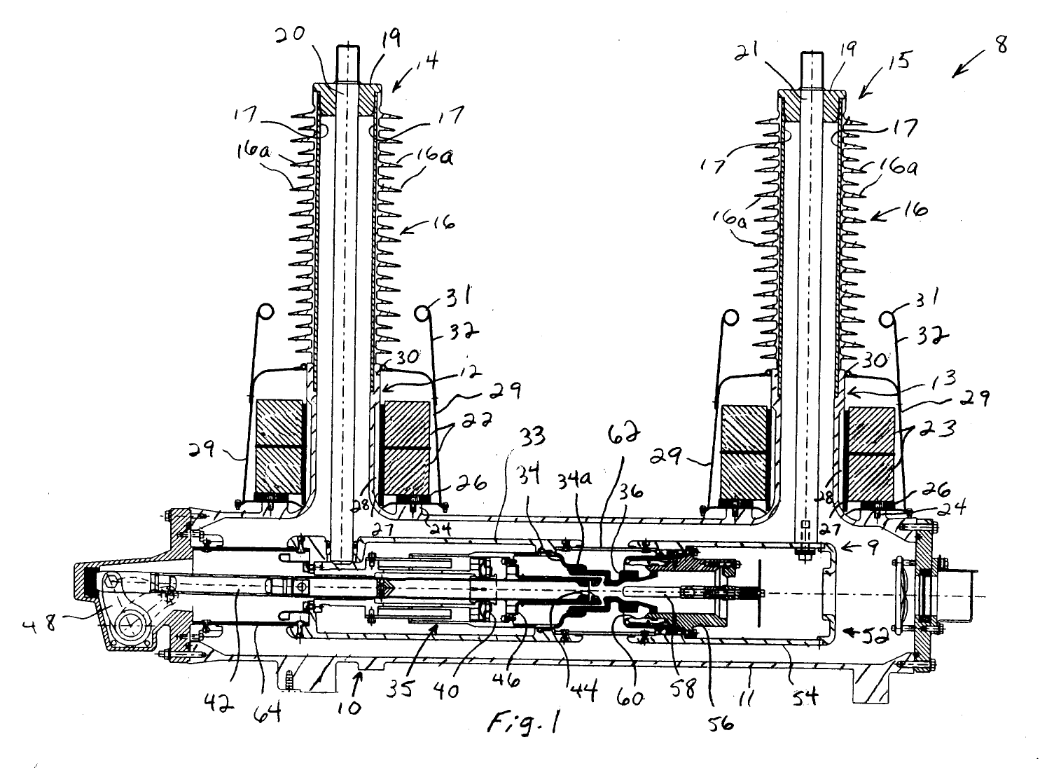

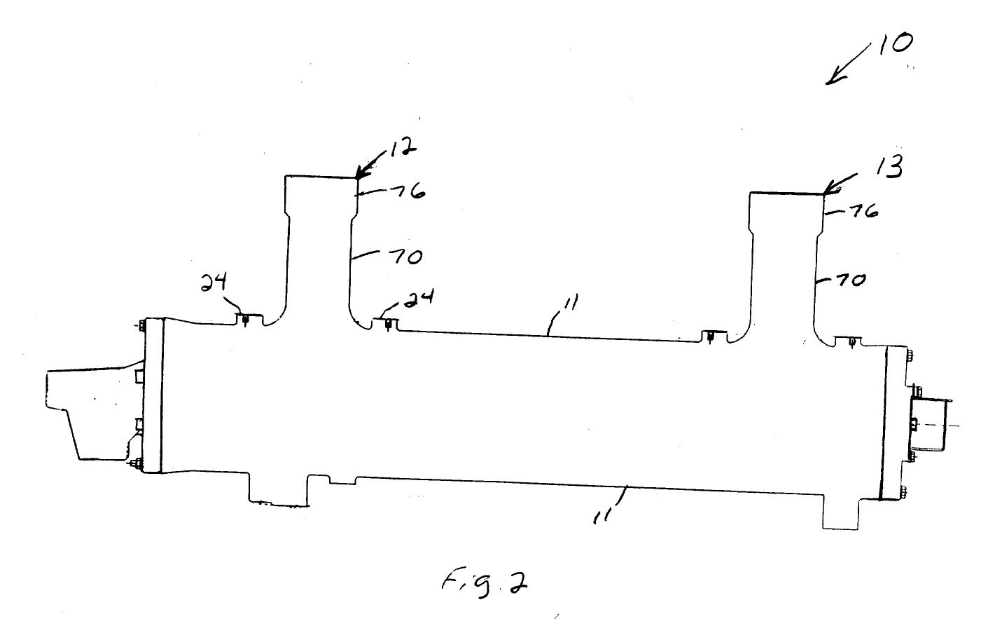

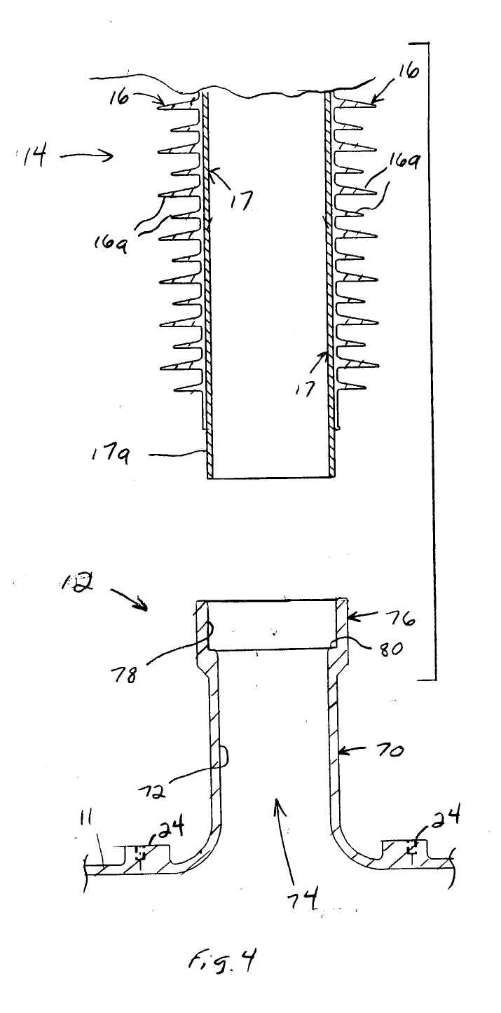

A preferred embodiment of a single-phase, dead-tank circuit breaker 8 is depicted in FIGS. 1-6. The circuit breaker 8 comprises a conventional puffer interrupter assembly 9, and a hermetically-sealed tank 10 (the puffer interrupter assembly 9 can be substantially identical to the puffer interrupter assembly 101 noted above). The tank 10 includes a substantially cylindrical main portion 11 for housing the puffer interrupter assembly 9 (see FIGS. 1 and 2). The tank 10 also includes an entrance bushing nozzle 12, and a substantially identical exit bushing nozzle 13. The entrance and exit bushing nozzles 12, 13 each adjoin the main portion 11. The main portion 11 and the entrance and exit bushing nozzles 12, 13 are preferably formed on a unitary basis.

The circuit breaker 8 also comprises an entrance bushing insulator 14 and an exit bushing insulator 15. The entrance bushing insulator 14 and the exit bushing insulator 15 are mounted on the respective entrance bushing nozzle 12 and exit bushing nozzle 13, as discussed in detail below.

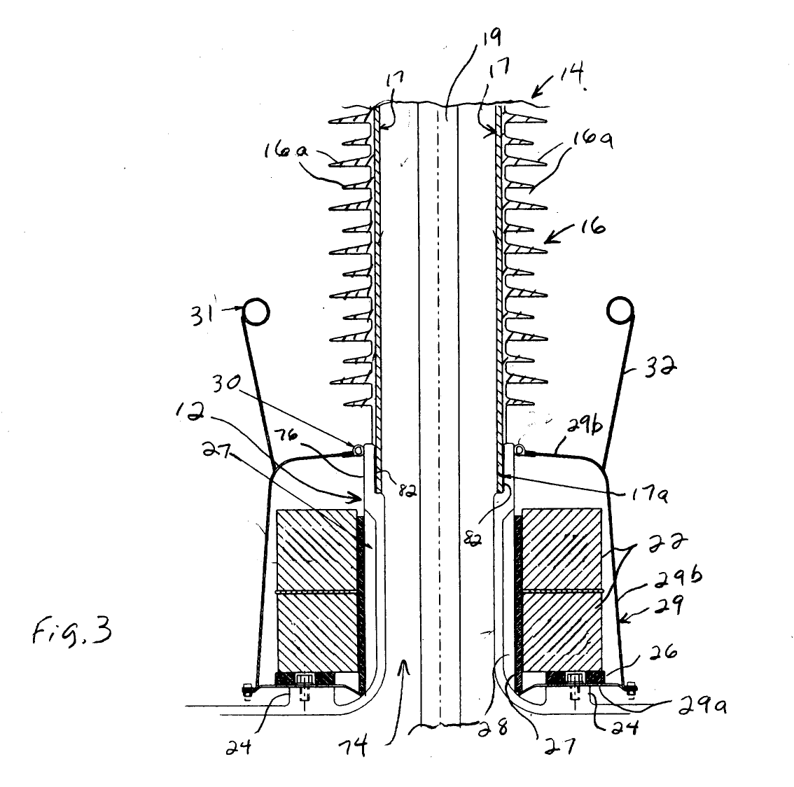

The entrance bushing insulator 14 comprises an outer jacket 16, and a substantially cylindrical inner sleeve 17 concentrically disposed within the outer jacket 16 (see FIGS. 1, 3, and 4). The outer jacket 16 is preferably molded from silicon or like material, and has a plurality of circumferentially-extending projections 16a formed thereon. The inner sleeve 17 is preferably formed from fiberglass or like material. A lower portion 17a of the inner sleeve 17 projects from the outer jacket 16 as shown, for example, in FIG. 4. In other words, the outer jacket 16 does not cover the lower portion 17a of the inner sleeve 17. The entrance bushing insulator 14 also comprises an end cap 19 secured to upper ends of the outer jacket 16 and the inner sleeve 17 (see FIG. 1).

The exit bushing insulator 15 is substantially identical to the entrance bushing insulator 14. Hence, the preceding description of the entrance bushing insulator 14 applies equally to the exit bushing insulator 15.

The circuit breaker 8 further comprises an entrance conductor 20 and an exit conductor 21 (see FIGS. 1 and 3). The entrance conductor 20 is fixedly coupled to the end cap 19 of the entrance bushing insulator 14, and extends through the entrance bushing insulator 14. The exit conductor 21 is fixedly coupled to the end cap 19 of the exit bushing insulator 15, and extends through the exit bushing insulator 15.

The circuit breaker 8 also includes a first current transformer 22 and a substantially identical second current transformer 23. The first current transformer 22 is electrically coupled to the entrance conductor 20, and to an ammeter (not shown) that provides an indication of the current passing through the entrance conductor 20. The second current transformer 23 is electrically coupled to the exit conductor 21, and to an ammeter (not shown) that provides an indication of the current passing through the exit conductor 21.

The first current transformer 22 is positioned around the entrance bushing nozzle 12, and is mounted on bosses 24 formed on the main portion 11 of the tank 9 (the bosses 24 can be formed as a flange in alternative embodiments). A first insulating spacer 26 is positioned between the bottom of the first current transformer 22 and the bosses 24 (see FIGS. 1 and 3). A second insulating spacer 27 is positioned around the inner circumference of the first current transformer 23. Four support ribs 28 can be formed as part of the entrance bushing nozzle 12 to maintain separation between the second spacer 27 and the remainder of the entrance nozzle bushing 12, as shown in FIGS. 1 and 3. It should be noted that the first current transformer 23 can be mounted using other arrangements in alternative embodiments of the circuit breaker 8.

The second current transformer 23 is positioned around the exit bushing nozzle 13. The second current transformer 23 is mounted on another set of the bosses 24 formed on the main portion 11, in a manner substantially identical to that described above with respect to the first current transformer 22.

The first current transformer 22 is enclosed by a metallic cover 29. The cover 29 preferably includes a first portion 29a and second portion 29b. The first portion 29a is secured to the bosses 24 using conventional fasteners. A bottom edge of the second portion 29b is secured to the first portion 29a using conventional fasteners.

The second portion 29b of the cover 29 has an aperture formed therein for receiving the entrance bushing nozzle 12 (see FIGS. 1 and 3). A gasket 30 is preferably secured to the second portion 29b, around the circumference of the aperture. The gasket 30 contacts the entrance bushing nozzle 12 as shown, for example, in FIG. 3. This contact can seal the interior of the cover 29 from the ambient environment, and can thereby reduce the potential for moisture and other environmental elements to reach the first current transformer 22.

Another of the covers 29 encloses the second current transformer 23, in a manner substantially identical to that described above with respect to the first current transformer 22.

The circuit breaker 8 can include two external voltage shields 31 (see FIGS. 1, 3, and 6). The external voltage shields 31 can help to shape the voltage fields around the entrance conductor 19 and the exit conductor 20, and can help to prevent electrical failure of the circuit breaker 8. The external voltage shields 31 are each preferably formed as a continuous ring having a substantially circular cross section.

One of external voltage shields 31 is positioned around the entrance bushing insulator 14, above the cover 29, as shown in FIGS. 1 and 3. The external voltage shield 31 is electrically and mechanically coupled to the cover 29 by a plurality of support strips 32. The circuit breaker 8 includes four of the support strips 32, spaced apart in substantially equal intervals around the circumference of the cover 29. Each support strip 32 is approximately two inches wide. It should be noted that the dimensions and total number of the support strips 32 have been specified for explanatory purposes only, as the optimum values for these parameters are application dependent.

The other of the external voltage shields 31 is mounted on the cover 29 of the second current transformer 23, in a manner substantially identical to that described above with respect to the first of the external voltage shields 31.

The puffer interrupter assembly 9 comprises a movable contact assembly 35 and a support shield 33 (see FIG. 1). The support shield 33 is electrically coupled to the entrance conductor 20.

The movable contact assembly 35 comprises a moving contact cylinder 34, and an insulating nozzle 36 fixedly coupled to the moving contact cylinder 34. The movable contact assembly 35 also comprises a piston 40, an insulated operating rod 42, and arcing contact fingers 44. The piston 40 is fixedly coupled to the support shield 33. The operating rod 42 extends freely through the support shield 33 and the piston 40. The operating rod 42 is fixedly coupled to the moving contact cylinder 34 by way of a flange 46. The arcing contact fingers 44 are fixedly coupled to the operating rod 42 by way of the flange 46.

The puffer interrupter assembly 9 also includes an operating lever 48, and an operating mechanism (not shown) that rotates the operating lever on a selective basis. The operating lever 48 is mechanically coupled to an end of the operating rod 42. Rotation of the operating lever 48 causes the operating rod 42 (and the moving contact cylinder 34 and arcing contact fingers 44) to move in the axial direction, i.e., toward and away from the ends of the tank 10. The significance of this feature is discussed below.

The puffer interrupter assembly 9 also comprises a stationary contact assembly 52. The stationary contact assembly 52 comprises a support shield 54 and a stationary contact support 56. The support shield 54 is fixedly coupled to the exit conductor 21. The stationary contact support 56 is positioned within, and is fixedly coupled to the support shield 54.

The stationary contact assembly 52 also comprises an arcing contact rod 58 and a contact assembly 60. The arcing contact rod 58 is fixedly coupled to, and extends through the stationary contact support 56. The contact assembly 60 is fixedly coupled to an end of the stationary contact support 56, and extends circumferentially around the end of the stationary contact support 56.

A first insulating tube 62 is fixedly coupled to a first end of the support shield 33, and to an adjacent end of the support shield 54. A second insulating tube 64 is fixedly coupled to a second end of the support shield 33.

The free volume within the puffer interrupter assembly 9 and the entrance and exit bushing insulators 14, 15 is filled with a dielectric gas such as sulfur hexafluoride (SF₆). The SF₆ gas can be pressurized to, for example, approximately four to seven atmospheres.

The operating rod 42, moving contact cylinder 34, and arcing contact fingers 44 translate in the axial direction in response to actuation of the operating mechanism, as noted above. In particular, axial movement of the operating rod 42 drives the moving contact cylinder 34 and the arcing contact fingers 44 between an “open” and a “closed” position. (FIG. 1 depicts the moving contact cylinder 34 and the arcing contact fingers 44 in the open position; movement of the moving contact cylinder 34 and the arcing contact fingers 44 in a rightward direction drives the moving contact cylinder 34 and the arcing contact fingers 44 toward the closed position.)

A forward portion 34a of the moving contact cylinder 34 contacts the inner circumference of the contact assembly 60, and the arcing contact fingers 44 contact the arcing contact rod 58 when the moving contact cylinder 34 is in its closed position. This arrangement establishes electrical contact between the entrance and exit conductors 20, 21, and thereby facilitates the flow of electrical current through the circuit breaker 8. More particularly, the noted arrangement establishes an electrical path comprising the entrance conductor 14, support shield 33, moving contact cylinder 34, arcing contact fingers 44, arcing contact rod 58, contact assembly 60, stationary contact support 56, support shield 54, and exit conductor 21.

Movement of the moving contact cylinder 34 and the arcing contact fingers 44 to the open position breaks the above-noted contact between the moving contact cylinder 34 and the contact assembly 60, and between the arcing contact fingers 44 and the arcing contact rod 58. Movement of the moving contact cylinder 34 and the arcing contact fingers 44 to the open position thus interrupts the flow of electrical current between the entrance and exit conductors 20, 21.

The flange 46 is fixedly coupled to the operating rod 42, and therefore translates with the moving contact cylinder 34 and the arcing contact fingers 44. More particularly, the flange 46 translates toward the stationary piston 40 when the moving contact cylinder 34 and the arcing contact fingers 44 move from the closed to the open position.

The translation of the flange 46 compresses the SF₆ gas located between the flange 46 and the piston 40. Through holes (not shown) formed in the flange 46 permit the compressed SF₆ gas to flow toward the stationary contact assembly 52. More particularly, the SF₆ gas flows through the nozzle 36. The nozzle 36 directs the SF₆ gas toward the interface between the moving contact cylinder 34 and the contact assembly 60. The nozzle 36 also directs the SF₆ gas toward the interface between the arcing contact fingers 44 and the arcing contact rod 58.

The SF₆ gas can help to cool and quench the arc that forms between the moving contact cylinder 34 and the contact assembly 60 during separation thereof. The SF₆ gas can also help to quench the arc that forms between the arcing contact fingers 44 and the arcing contact rod 58 during separation thereof. (The SF₆ gas can also act as an electrical insulator between the walls of the tank 10 and the various components housed therein.)

Further details of the puffer interrupter assembly 9 are not necessary for an understanding of the present invention, and therefore are not presented herein. Moreover, it should be noted that specific details of the structure and operation of the puffer interrupter assembly 9 have been presented for exemplary purposes only, as the present invention can be applied to circuit breakers comprising virtually any type of interrupter.

The entrance bushing insulator 14 and the exit bushing insulator 15 are mounted on the respective entrance and exit bushing nozzles 12, 13 of the tank 10, as noted previously. Details relating to the mounting of the entrance bushing insulator 14 on the entrance bushing nozzle 12 are as follows. (The entrance bushing insulator 14 and the exit bushing insulator 15 are mounted on the respective entrance and exit bushing nozzles 12, 13 in a substantially identical manner. Details relating to the mounting of the entrance bushing insulator 14 on the entrance bushing nozzle 12 therefore apply equally to the mounting of the exit bushing insulator 15 on the exit bushing nozzle 13.)

The entrance bushing nozzle 12 includes a lower portion 70 that adjoins the main portion 11 of the tank 10 (see FIG. 4). The lower portion 70 has a circumferentially-extending inner surface 72. The inner surface 72 defines a lower portion of a passage 74 for receiving the entrance conductor 20.

The entrance bushing nozzle 12 also includes an upper portion 76 that adjoins the lower portion 70. The upper portion 76 has a circumferentially-extending inner surface 78 that defines an upper portion of the passage 74. The upper portion 76 also includes a stepped surface 80 that adjoins the inner surface 78, and is substantially perpendicular thereto.

The entrance bushing insulator 14 is mounted on the upper portion 76 of the entrance bushing nozzle 12. More particularly, the upper portion 76 of the entrance bushing insulator 14 receives the lower portion 17a of the inner sleeve 17, as shown in FIGS. 1 and 3. Preferably, the length of the lower portion 17a is approximately equal to the height (vertical dimension) of the inner surface 78. This feature permits a substantial entirety of the lower portion 17a to be positioned within the upper portion 76. Moreover, the upper portion 76 is preferably dimensioned so that minimal clearance, e.g., approximately five to approximately ten mils, exists between the inner surface 78 and an outer surface of the lower portion 17a.

The lower portion 17a is secured to the upper portion 76 by a suitable adhesive. For example, a cold adhesive joint 82 can be formed between the lower portion 17a and the upper portion 76, in a manner commonly known to those skilled in the art of manufacturing circuit breakers (see FIG. 3). In particular, a thin, e.g., five-mil, continuous layer of unheated epoxy adhesive can be applied to the inner surface 78 of the entrance bushing nozzle 12. Another thin, e.g., five-mil, continuous layer of unheated epoxy adhesive can be applied to the outer surface of the lower portion 17a.

The lower portion 17a can subsequently be inserted into the upper portion 76 until the lower edge of the lower portion 17a contacts the stepped surface 80. (The cover 29 should be installed on the entrance bushing nozzle 12 before the lower portion 17a is inserted into the upper portion 76.)

The epoxy adhesive, upon curing, forms the adhesive joint 82. The adhesive joint 82 acts as both a mechanical joint and a gas seal between the surface 78 of the entrance bushing nozzle 12, and the lower portion 17a entrance bushing insulator 14. The adhesive joint 82 can thus secure the entrance bushing insulator 14 to the entrance bushing nozzle 12. The adhesive joint 82 can also seal the mechanical interface between the entrance bushing insulator 14 to the entrance bushing nozzle 12, and can thereby inhibit leakage of the pressurized SF₆ gas from the circuit breaker 8.

The adhesive joint 82 is believed to provide particularly effective sealing. More specifically, the continuity of the adhesive layer that forms the adhesive joint 82 is believed to substantially reduce the potential for leakage of the pressurized SF₆ gas, in comparison to conventional sealing arrangements such as the flanges 110, 111 discussed above. The sealing effectiveness of the adhesive joint 82 is also believed to reduce the potential for moisture and other environmental elements to enter the circuit breaker 8, thereby reducing the potential for corrosion of the internal components of the circuit breaker 8.

The enhanced sealing effectiveness believed to be provided by the adhesive joint 82 can be particularly beneficial in multi-phase circuit breakers. For example, even relatively small amounts of leakage through the six flange interfaces in a conventional three-phase circuit breaker can lead to substantial depletion of the SF₆ gas, or a substantial inflow of environmental elements, over a relatively short period. Hence, reducing or eliminating such leakage can potentially extend the maintenance intervals and the service life of the circuit breaker.

Securing the entrance and exit bushing insulators 14, 15 to the respective entrance and exit bushing nozzles 12, 13 using the adhesive joint 82 can obviate the need for flanges, such as the flanges 110, 111, on the noted components. Eliminating the use of such flanges can permit the first and second current transformers 22, 23 to be constructed with a smaller overall diameter and a lower weight than would otherwise be possible. For example, it is believed that eliminating the use of the flanges 110, 111 in the circuit breaker 9 can permit the first and second current transformers 22, 23 to be constructed with an overall diameter approximately twenty-five percent smaller than would otherwise be possible.

Moreover, it is believed that the use of a voltage shield located externally to the cover 29, such as the external voltage shield 31, can permit the first and second current transformers 22, 23 to be constructed with a smaller overall diameter and a lower weight than would otherwise be possible.

Eliminating the use of flanges such as the flanges 110, 111 can also lead to reductions in the overall parts count of the circuit breaker 8. Moreover, the relatively simple shape of the entrance and exit bushing nozzles 12, 13 is believed to make the tank 10 easier to manufacture than a tank of conventional design.

It is to be understood that even though numerous characteristics of the present invention have been set forth in the foregoing description, the disclosure is illustrative only and changes may be made in detail within the principles of the invention to the full extent indicated by the broad general meaning of the terms in which the appended claims are expressed. For example, the concepts of the present invention can be applied to virtually any type of circuit breaker comprising bushing insulators including, for example, live tank and multi-phase circuit breakers.

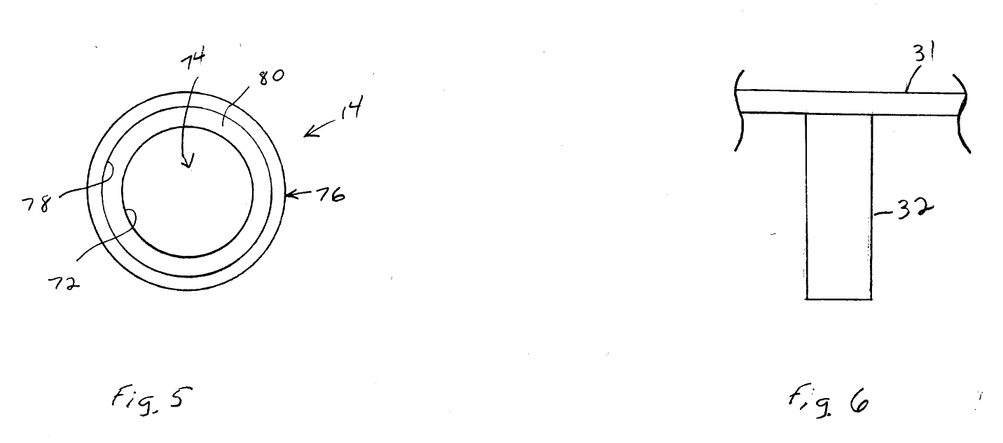

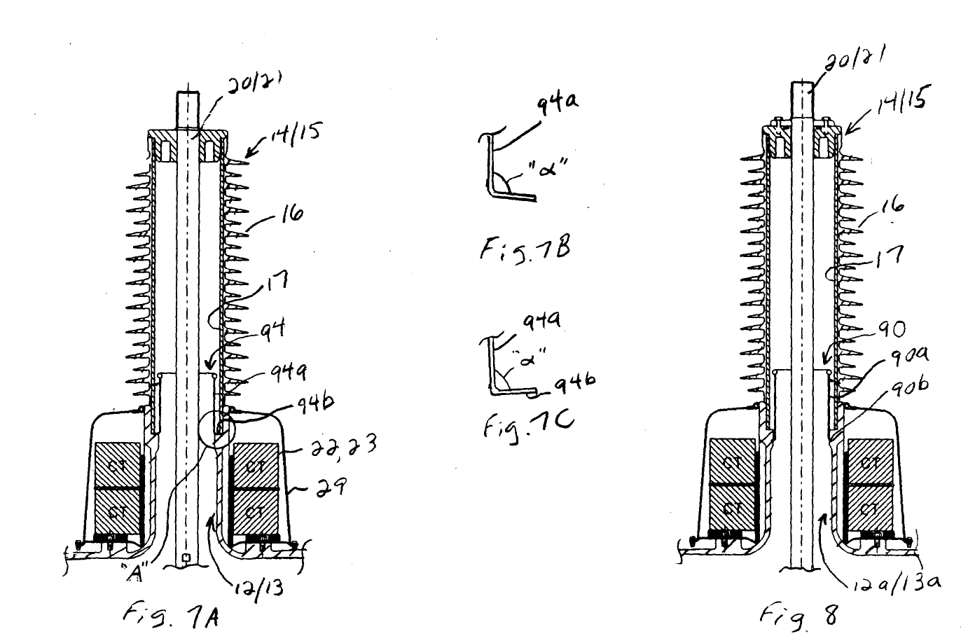

FIGS. 7A-7C depicts an internal voltage shield 94 that can be used in lieu of the external voltage shield 31. The internal voltage shield 94 includes a substantially cylindrical main portion 94a, and a circumferentially-extending lip 94b formed along a lower edge of the main portion 94a. The lip 94b is secured between the stepped surface 80 of the entrance or exit bushing nozzles 12, 13, and the bottom edge of the inner sleeve 17 of the entrance or exit bushing insulators 14, 15.

The lip 94b is preferably formed (or bent) so that an angle between the main portion 94a and the lip 94b is greater than approximately ninety degrees before the voltage shield 94 is installed on the entrance or exit bushing nozzle 12, 13, as shown in FIG. 7B. (The angle between the main portion 94a and the lip 94b is denoted by the symbol “α” in FIGS. 7B and 7C.) Most preferably, the angle α is approximately ninety-five degrees before the voltage shield 94 is installed on the entrance or exit bushing nozzle 12, 13.

The lip 94b is pressed downward by the bottom edge of the inner sleeve 17 as the entrance or exit bushing insulators 14, 15 are installed on the respective entrance and exit bushing nozzles 12, 13. This action deforms the lip 94b so that the angle α decreases to approximately ninety degrees, as shown in FIG. 7C. Deforming the lip 94b in this manner is believed to lessen the potential for the lip 94a to loosen once the adhesive securing the entrance and exit bushing insulators 14, 15 to the respective entrance and exit bushing nozzles 12, 13 has cured. Deforming the lip 94b in this manner is also believed to enhance the electrical contact between the voltage shield 94 and the entrance and exit bushing nozzles 12, 13.

The internal voltage shield 94 is believed to be more compact than the conventional voltage shield 122 discussed above, and can thereby lead to reductions in the overall dimensions and weight of the first and second current transformers 22, 23.

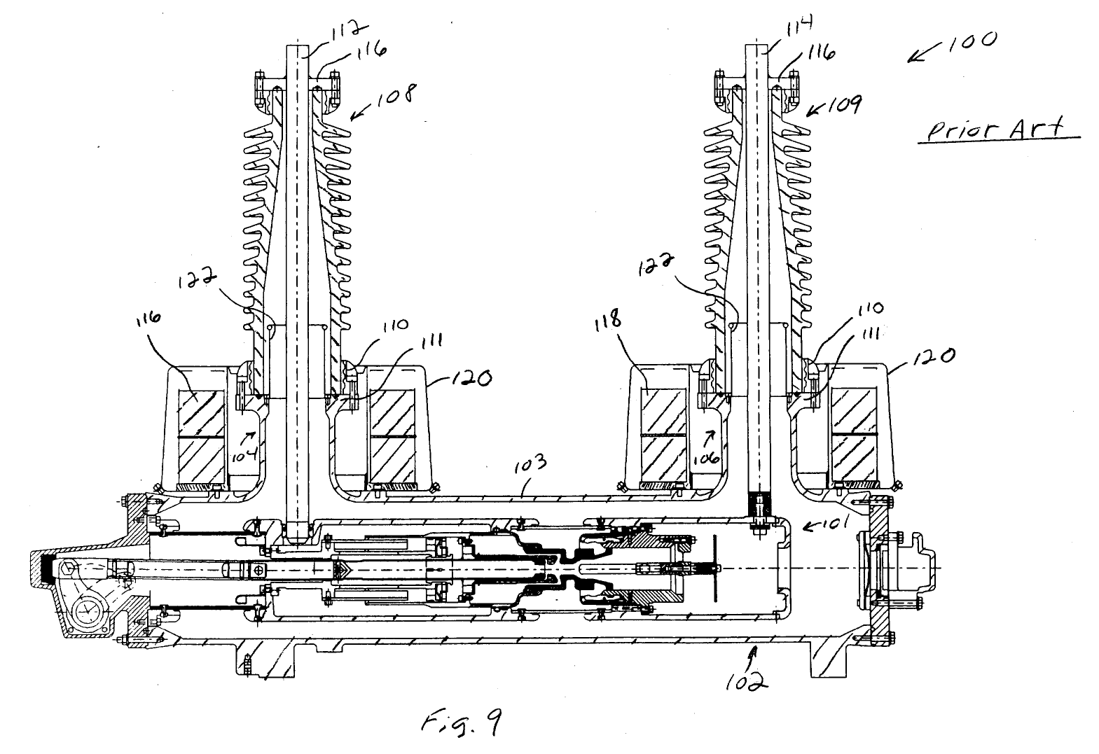

FIG. 8 depicts another internal voltage shield 90 that can be used in lieu of the external voltage shield 31. The internal voltage shield 90 includes a substantially cylindrical main portion 90a, and a circumferentially-extending lip 90b formed along a lower edge of the main portion 90a. The lip 90b engages a groove in an inner circumferential surface of an entrance bushing nozzle 12a or an exit bushing nozzle 13a (the entrance and exit bushing nozzles 12a, 13a are otherwise substantially identical to the entrance and exit bushing nozzles 12, 13).

The internal voltage shield 90 is believed to be more compact than the conventional voltage shield 122 discussed above, and can thereby lead to reductions in the overall dimensions and weight of the first and second current transformers 22, 23.

Parts List

Circuit breaker 8

Puffer interrupter assembly 9

Tank 10

Main portion 11 (of tank 10)

Entrance bushing nozzle 12

Entrance bushing nozzle 12a

Exit bushing nozzle 13

Exit bushing nozzle 13a

Entrance bushing insulator 14

Exit bushing insulator 15

Outer jacket 16 (of entrance and exit bushing insulators 14, 15)

Inner sleeve 17

Lower portion 17a (of inner sleeve 17)

End cap 19

Entrance conductor 20

Exit conductor 21

First current transformer 22

Second current transformer 23

Bosses 24 (on tank 10)

First insulating spacer 26

Second insulating spacer 27

Support ribs 28

Covers 29 (for first and second current transformers 22, 23)

Gasket 30

External voltage shield 31

Support strips 32

Support shield 33

Moving contact cylinder 34

Movable contact assembly 35

Insulating nozzle 36

Piston 40

Operating rod 42

Arcing contact fingers 44

Flange 46

Operating lever 48

Stationary contact assembly 52

Support shield 54 (of stationary contact assembly 52)

Stationary contact support 56

Arcing contact rod 58

Contact assembly 60

First insulating tube 62

Second insulating tube 64

Lower portion 70 (of entrance bushing nozzle 12)

Inner surface 72 (of lower portion 70)

Passage 74 through entrance and exit bushing nozzles 14, 15

Upper portion 76 (of entrance bushing nozzle 12)

Inner surface 78 of upper portion 76

Stepped surface 80

Adhesive joint 82

Internal voltage shield 90

Main portion 90a (of internal voltage shield 90)

Lip 90b

Internal voltage shield 94

Main portion 94a (of internal voltage shield 94)

Lip 94b

Conventional circuit breaker 100

Puffer interrupter assembly 101

Tank 102

Main portion 103 (of tank 102)

Entrance bushing nozzle 104

Exit bushing nozzle 106

Entrance bushing insulator 108

Exit bushing insulator 109

Flanges 110 (on entrance and exit bushing insulators 108, 109)

Flanges 111 (on entrance and exit bushing nozzles 104, 106)

Entrance conductor 112

Exit conductor 114

End caps 116 (of entrance and exit bushing insulators 108, 109)

First current transformer 116

Second current transformer 118

Covers 120 (for first and second current transformers 116,118)

Voltage shield 122

1. A circuit breaker, comprising:
a first and a second bushing insulator;
a first and a second electrical conductor extending through the respective first and second bushing insulators; and
a tank having a main portion for housing an interrupter assembly, and a first and a second bushing nozzle adjoining the main portion, wherein the first bushing insulator and the second bushing insulator are secured directly to the respective first and second bushing nozzles by an adhesive material.

2. The circuit breaker of claim 1, further comprising the interrupter assembly, wherein the interrupter assembly is electrically coupled to the first and second electrical conductors and selectively interrupts a flow of electrical current between the first and second electrical conductors.

3. The circuit breaker of claim 2, wherein the interrupter assembly is a puffer interrupter assembly.

4. The circuit breaker of claim 1, further comprising a current transformer electrically coupled to the first electrical conductor, and a cover for enclosing the current transformer.

5. The circuit breaker of claim 4, further comprising a voltage shield positioned around an exterior of the first bushing insulator, and a plurality of support strips for mechanically and electrically coupling the voltage shield to the cover.

6. The circuit breaker of claim 5, wherein the voltage shield has a substantially circular cross section.

7. The circuit breaker of claim 4, further comprising a seal secured to the cover and positioned between the cover and the first bushing nozzle for sealing an interior of the cover.

8. The circuit breaker of claim 1, wherein the first bushing nozzle has a lower portion adjoining the main portion of the tank, and an upper portion adjoining the lower portion for receiving at least a portion of the first bushing insulator.

9. The circuit breaker of claim 8, wherein the upper portion has a circumferentially-extending inner surface, the lower portion has a circumferentially-extending inner surface, and the first bushing nozzle has a stepped surface that adjoins the inner surfaces of the upper and lower portions.

10. The circuit breaker of claim 9, further comprising a voltage shield positioned at least in part within the first bushing insulator, the voltage shield having a main portion and a lip, the lip being fixedly coupled to the stepped surface.

11. The circuit breaker of claim 10, wherein the lip is angled in relation to the main portion by an angle greater than approximately ninety degrees before the lip is fixedly coupled to the stepped surface, and the lip is angled in relation to the main portion by an angle of approximately ninety degrees when the lip is fixedly coupled to the stepped surface.

12. The circuit breaker of claim 11, wherein the angle greater than approximately ninety degrees is approximately ninety-five degrees.

13. The circuit breaker of claim 10, wherein the lip is positioned between an edge of the first bushing insulator and the stepped surface.

14. The circuit breaker of claim 1, further comprising a voltage shield positioned at least in part within the first bushing insulator, the voltage shield having a main portion and a lip, the lip being positioned in a groove formed in the first bushing nozzle.

15. The circuit breaker of claim 1, wherein the first bushing insulator comprises an outer jacket and a substantially cylindrical inner sleeve concentrically disposed within the outer jacket.

16. The circuit breaker of claim 15, wherein:
the first bushing nozzle has a lower portion adjoining the main portion of the tank, and an upper portion adjoining the lower portion;
a portion of the inner sleeve of the first bushing insulator projects from the outer jacket; and
the upper portion of the first bushing nozzle receives the portion of the inner sleeve.

17. The circuit breaker of claim 16, wherein the upper portion of the first bushing nozzle has a circumferentially-extending inner surface, the lower portion of the first bushing nozzle has a circumferentially-extending inner surface, the first bushing nozzle has a stepped surface that adjoins the inner surfaces of the upper and lower portions, and the portion of the inner sleeve of the first bushing insulator abuts the stepped surface.

18. The circuit breaker of claim 16, wherein the adhesive material comprises a layer of the adhesive material located between the upper portion of the first bushing nozzle and the portion of the inner sleeve.

19. The circuit breaker of claim 15, wherein the inner sleeve is formed from a fiberglass material.

20. The circuit breaker of claim 15, wherein the outer jacket is formed from a silicon material.

21. The circuit breaker of claim 1, wherein the adhesive material is an epoxy adhesive.

22. The circuit breaker of claim 4, wherein the current transformer is spaced apart from the first bushing nozzle by a plurality of ribs.

23. The circuit breaker of claim 1, wherein the tank has a pressurized gas therein and the adhesive material inhibits leakage of the pressurized gas from the tank.

24. A circuit breaker, comprising:
an electrical conductor;
a bushing insulator comprising a jacket for insulating the electrical conductor;
a tank having a main portion for housing an interrupter assembly electrically coupled to the electrical conductor, and a bushing nozzle adjoining the main portion; and
an adhesive joint formed directly between the bushing insulator and the bushing nozzle for securing the bushing insulator to the tank and sealing an interface between the bushing insulator and the tank.

25. The circuit breaker of claim 24, wherein:
the bushing nozzle has a lower portion adjoining the main portion of the tank, and an upper portion adjoining the lower portion;
the bushing insulator further comprises a substantially cylindrical inner sleeve concentrically disposed within the jacket;
a portion of the inner sleeve projects from the outer jacket; and
the upper portion receives the portion of the inner sleeve and the portion of the inner sleeve is adhesively bonded to the upper portion.

26. The circuit breaker of claim 24, wherein the adhesive joint is formed from an epoxy adhesive.

27. The circuit breaker of claim 24, further comprising the interrupter assembly.

28. A circuit breaker, comprising:
a tank having a main portion for housing an interrupter assembly;
a bushing insulator adhesively bonded directly to the tank; and
an electrical conductor extending through the bushing insulator and electrically coupled to the interrupter assembly.

29. The circuit breaker of claim 28, wherein:
the tank further comprises a bushing nozzle having a lower portion adjoining the main portion, and an upper portion adjoining the lower portion;
the bushing insulator comprises an outer jacket and a substantially cylindrical inner sleeve concentrically disposed within the outer jacket;
a portion of the inner sleeve projects from the outer jacket; and
the upper portion receives the portion of the inner sleeve and the portion of the inner sleeve is adhesively bonded to the upper portion.

30. The circuit breaker of claim 28, wherein the bushing insulator is adhesively bonded to the tank by an epoxy adhesive.

31. The circuit breaker of claim 28, further comprising the interrupter assembly.

32. A circuit breaker, comprising:
a bushing insulator comprising an outer jacket and a substantially cylindrical inner sleeve concentrically disposed within the outerjacket so that a portion of the inner sleeve projects from the outer jacket;
an electrical conductor extending through the bushing insulator; and
a tank having a main portion for housing an interrupter assembly, and a bushing nozzle having a lower portion adjoining the main portion of the tank and an upper portion for receiving the portion of the inner sleeve, wherein the portion of the inner sleeve is adhesively bonded directly to the upper portion of the bushing nozzle.

33. The circuit breaker of claim 32, further comprising the interrupter assembly, wherein the interrupter assembly selectively interrupts a flow of electrical current between the electrical conductor and another of the electrical conductors.

34. (canceled)

35. The circuit breaker of claim 32, further comprising a current transformer electrically coupled to the electrical conductor, and a cover for enclosing the current transformer.

36. The circuit breaker of claim 35, further comprising a voltage shield positioned around an exterior of the bushing insulator, and a plurality of support strips for mechanically and electrically coupling the voltage shield to the cover.

37. The circuit breaker of claim 36, wherein the voltage shield has a substantially circular cross section.

38. The circuit breaker of claim 35, further comprising a seal secured to the cover and positioned between the cover and the bushing nozzle for sealing an interior of the cover.

39. The circuit breaker of claim 32, wherein the upper portion of the bushing nozzle has a circumferentially-extending inner surface, the lower portion of the bushing nozzle has a circumferentially-extending inner surface, and the bushing nozzle has a stepped surface that adjoins the inner surfaces of the upper and lower portions.

40. The circuit breaker of claim 39, further comprising a voltage shield positioned at least in part within the bushing insulator, the voltage shield having a main portion and a lip, the lip being fixedly coupled to the stepped surface.

41. The circuit breaker of claim 40, wherein the lip is angled in relation to the main portion by an angle greater than approximately ninety degrees before the lip is fixedly coupled to the stepped surface, and the lip is angled in relation to the main portion by an angle of approximately ninety degrees when the lip is fixedly coupled to the stepped surface.

42. The circuit breaker of claim 41, wherein the angle greater than approximately ninety degrees is approximately ninety-five degrees.

43. The circuit breaker of claim 40, wherein the lip is positioned between an edge of the first bushing insulator and the stepped surface.

44. The circuit breaker of claim 32, further comprising a voltage shield positioned at least in part within the first insulator, the voltage shield having a main portion and a lip, the lip being positioned in a groove formed in the bushing nozzle.

45. The circuit breaker of claim 32, wherein the bushing insulator comprises an outer jacket and a substantially cylindrical inner sleeve concentrically disposed within the outer jacket.

46. The circuit breaker of claim 45, wherein the upper portion has a circumferentially-extending inner surface, the lower portion has a circumferentially-extending inner surface, the bushing nozzle has a stepped surface that adjoins the inner surfaces of the upper and lower portions, and the portion of the inner sleeve of the bushing insulator abuts the stepped surface.

47. The circuit breaker of claim 34, wherein the portion of the inner sleeve is adhesively bonded to the upper portion of the bushing nozzle by an epoxy adhesive.

48. The circuit breaker of claim 32, wherein the inner sleeve is formed from a fiberglass material.

49. The circuit breaker of claim 32, wherein the outer jacket is formed from a silicon material.

50. The circuit breaker of claim 33, wherein the interrupter assembly is a puffer interrupter assembly.

51. A method for assembling a circuit breaker, comprising:
providing a tank for housing an interrupter assembly;
providing a bushing insulator for insulating an electrical conductor; and
bonding the bushing insulator directly to the tank using an adhesive material.

52. The method of claim 51, wherein bonding the bushing insulator directly to the tank using an adhesive material comprises bonding the bushing insulator to the tank using an epoxy adhesive.

53. The method of claim 51, wherein bonding the bushing insulator directly to the tank using an adhesive material comprises coating a surface of an upper portion of a bushing nozzle of the tank with the adhesive, coating a surface of a portion of the bushing insulator with the adhesive, and inserting the portion of the bushing insulator into the upper portion.

54. The method of claim 51, further comprising inserting a portion of an inner sleeve of the bushing insulator in an upper portion of a bushing nozzle of the tank after applying the adhesive material to at least one of the portion of the inner sleeve and the upper portion of the bushing nozzle.
